(19) United States
(12) Patent Application Publication
(10) Pub. No.: US 2007/0061188 A1
(43) Pub. Date: Mar. 15, 2007

(54) Method for providing tailored product information

(76) Inventors: Samantha Marie Sakemiller, Batavia, OH (US); Mary Jane Woods, Hebron, KY (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/222,635

(22) Filed: Sep. 9, 2005

(51) Int. Cl. G06F 17/30

(52) U.S. Cl. 705/10

(57) ABSTRACT

A method of providing tailored product information to a consumer. The method includes the steps of: collecting information from a plurality of consumers; establishing at least a first consumer grouping and a second consumer grouping; placing each consumer in either the first consumer grouping or the second consumer grouping based upon the information collected from each consumer; providing information about the product to the first consumer grouping in a predetermined first format; and providing information about the product to the second consumer grouping in a predetermined second format which is different than the predetermined first format.

### FIELD OF THE INVENTION

This invention relates to a method for providing tailored product information to a consumer.

### BACKGROUND OF THE INVENTION

Providing information to consumers about a particular product has been done for many years. Many forums such as newspapers, magazines, television, signs, radio, email and the internet have been used to provide this information.

Collecting information about consumers spending habits and likes and dislikes has also been done for many years. Information is collected through surveys and questionnaires. Information is also collected by monitoring consumer spending habits at retail stores and through the internet.

Once the information is collected consumers are placed into certain groupings. These groupings then determine the likelihood of a consumer to purchase a certain type of product. For example, when it comes to automobiles there are numerous groupings created to define which vehicles are likely to be purchased by each grouping.

For example, a young single man will likely be placed into a grouping that identifies with the high likelihood of his being interested in purchasing a pickup truck. With this information the automobile manufacturer will create a certain type of advertising directed at this particular grouping trying to make their pickup truck appealing.

Another example, would be a married mother with children will likely be placed into a grouping that identifies with the high likelihood of her being interested in purchasing a minivan. With this information the automobile manufacturer will create a certain type of advertising directed at this particular grouping trying to make their minivan appealing.

This targeted marketing is carried out across numerous categories as it provides an effective, cost efficient way to provide product information to a certain group of consumers.

The inventor has found a unique way to market the exact same product to multiple groupings by providing tailored product information to each grouping. This allows the marketer to obtain the greatest opportunity to sell the product to the greatest number of consumers by presenting the product to each consumer in a way that is best suited for that consumer.

### SUMMARY OF THE INVENTION

The present invention provides a method of providing tailored product information to a consumer. The method comprises the steps of: collecting information from a plurality of consumers; establishing at least a first consumer grouping and a second consumer grouping; placing each consumer in either said first consumer grouping or said second consumer grouping based upon said information collected from each consumer; providing information about said product to said first consumer grouping in a predetermined first format; providing information about said product to said second consumer grouping in a predetermined second format which is different than said predetermined first format.

The information collected includes a consumer's attitudes, life experiences and menstrual cycle.

The first and second formats include colors, words, designs and sounds.

The product is selected from the group consisting of automobiles, laundry products, cosmetics, foods, medicines, appliances, electronics, cameras, disposable absorbent articles, personal hygiene products, and vision products.

The information collecting is accomplished through the use of a computer.

### DETAILED DESCRIPTION OF THE INVENTION

While the specification concludes with claims particularly pointing out and distinctly claiming the subject matter which is regarded as forming the present invention, it is believed that the present invention will be better understood from the following description.

The method of the present invention relates to a method of providing tailored product information to a consumer. The method comprises the steps of: collecting information from a plurality of consumers; establishing at least a first consumer grouping and a second consumer grouping; placing each consumer in either said first consumer grouping or said second consumer grouping based upon said information collected from each consumer; providing information about said product to said first consumer grouping in a predetermined first format; providing information about said product to said second consumer grouping in a predetermined second format which is different than said predetermined first format.

The information can be collected from consumers in a variety of ways. It can be collected through the use of a computer. The information can be collected through the use of questionnaires and surveys. The questionnaires and surveys can be conducted through the use of a computer. They can also be sent out through email and conventional mail. The questionnaires and surveys can be conducted in person. Information can also be collected through interactive television.

The information collected from consumers includes their attitudes, life experiences and menstrual cycle. The attitudes and life experiences can be related to their attitudes and life experiences with a s specific type of product. For example, a questionnaire might ask about the consumer's attitudes and experiences with automobiles. The attitudes and life experiences can be unrelated to any product. For example, a questionnaire might ask about the consumer's attitudes and experiences concerning work, school, family members and friends.

Menstrual cycle information includes but is not limited to whether or not she has had her first period, if she has had a few periods, if she has had numerous periods, does she worry about leaks, does she have light flow, and does she have heavy flow.

Consumer groupings are created. At least two consumer groupings are needed to distinguish between the consumers. However, the number of consumer groupings created can be as many are needed to create the appropriate number of groupings to distinguish between the consumers.

Each consumer is then placed in a consumer grouping based upon the information collected from each consumer. For example, a first consumer grouping of shy individuals may be created. A second consumer grouping of outgoing individuals may be created. Based on the information collected each consumer is placed in either the first consumer grouping of shy individuals or the second consumer grouping of outgoing individuals.

Information about a product is then provided to the first consumer grouping in a predetermined first format. For example, if the product is an automobile the information provided to the shy individuals might include that the automobile is quiet and provides an opportunity for escape from all the interactions with other people. Information about the automobile is provided to the second consumer grouping in a predetermined second format. The second format is different than the first format. For example, the information for the second consumer grouping of outgoing individuals might include that the automobile is big and roomy providing them ample space for their friends and family to take along with them on rides in the automobile.

In addition to different words, the first and second formats also include colors, designs and sounds. For example, a first consumer grouping might like blue and a second consumer grouping might like red. Thus information to the first grouping will be provided in blue and the information provided to the second consumer grouping will be provided in red.

The product can be any product which is marketed to a group of consumers. For example the product may be selected from the group of automobiles, laundry products, cosmetics, foods, medicines, appliances, electronics, cameras, disposable absorbent articles, personal hygiene products, and vision products.

As used herein, the term “absorbent article” refers to devices which absorb and contain body exudates, and, more specifically, refers to devices which are placed against or in proximity to the body of the wearer to absorb and contain the various exudates discharged from the body. The term “disposable” is used herein to describe absorbent articles which are not intended to be laundered or otherwise restored or reused as an absorbent article (i.e., they are intended to be discarded after a single use and, preferably to be recycled, composted or otherwise disposed of in an environmentally compatible manner). The term “absorbent articles” includes sanitary napkins, panty liners (or pantiliners), incontinence devices, interlabial products, tampons, diapers, and training pants. The term “catamenial devices”, as used herein includes, but is not limited to sanitary napkins, pantiliners, incontinence devices, interlabial products, and tampons.

### EXAMPLES

The method of the present invention can be further illustrated according to the following examples.

### Example 1

The product is a catamenial device. A questionnaire is placed on an internet web page. Information about the consumers' attitudes, menstrual cycle and life experiences are collected through the use of computers as numerous consumers answer the questionnaire. In this particular example 18 groups of consumers experiences/personalities are established. The consumers are first broken into groups based on period experience. The groups are then further broken down based on personality and preference for receiving messaging. Finally, information about the consumers product usage and product loyalty are collected to determine the way in which the message will be presented. Messaging frequency, color, wording, font, sound, design and length will be altered based on each unique grouping.

For example, a consumer is identified to be a young female who has had her period for 4 years but still worried about leaks, she also considers herself shy. Additionally, she is loyal to thick sanitary napkins but is considering tampons. She is presented with information relevant to new tampon trial and myths or concerns. She will be shown articles which help her understand sensitive topics such as TSS. Finally she will be presented with messaging that is appropriate for her stage. This will provide the highest opportunity to develop a loyal consumer who experiences no leaks and is confident about her period.

In this same example another consumer is identified to be a young woman that is very comfortable with her period and is outgoing. Additionally, she uses tampons and pads in combination but occasionally experiences leaks. This consumer is presented with information about how to prevent leaks thru proper system usage of pads, tampons and liners. The messaging is customized to include opportunities for her to receive a custom sample kit and additional product loyalty opportunities.

### Example 2

The product is an automobile. A questionnaire is placed on an internet web page. Information about the consumers attitudes and life experiences is collected through the use of computers as numerous consumers answer the questionnaire. In this particular example a first consumer grouping of product dependability is established. A second consumer grouping of adventurous individuals is also established to provide a first consumer grouping and a second consumer grouping. Each consumer is placed in either the first consumer grouping, i.e., dependability or the second consumer grouping, i.e., adventurous, based upon the information collected from each consumer through the internet questionnaire.

Through an interactive web page, information about the automobile is provided to each person in the first consumer grouping in a first format. In this particular example, the first consumer grouping is shown words about the dependability of the automobile. The first consumer grouping is provided with songs that play in the background creating the perception of dependability. The first consumer grouping is shown designs and colors that are commonly acquainted with dependability.

The second consumer grouping is shown words about the adventures that can be had when driving the automobile. The second consumer grouping is provided with songs that play in the background creating the perception of adventure. The second consumer grouping is shown designs and colors that are commonly acquainted with being adventurous.

### Example 3

The product is a clothes washing machine. A questionnaire is placed on an internet web page. Information about the consumers attitudes and life experiences is collected through the use of computers as numerous consumers answer the questionnaire. In this particular example a first consumer grouping of those concerned about the environment is established. A second consumer grouping of those concerned about convenience is also established to provide a first consumer grouping and a second consumer grouping. Each consumer is placed in either the first consumer grouping, i.e., concerned about the environment, or the second consumer grouping, i.e., concerned about convenience, based upon the information collected from each consumer through the internet questionnaire.

Through an interactive web page, information about the clothes washing machine is provided to each person in the first consumer grouping in a first format. In this particular example, the first consumer grouping is shown words about the environmentally friendly features of the clothes washing machine. The first consumer grouping is provided with songs that play in the background relating to the environment. The first consumer grouping is shown designs of nature and colors such as green and blue that are commonly acquainted with the environment.

The second consumer grouping is shown words about the convenience of the clothes washing machine. The second consumer grouping is provided with songs that play in the background relating to convenience. The second consumer grouping is shown designs and colors that are commonly acquainted with convenience such as fast red moving objects.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of providing tailored product information to a consumer, said method comprising the steps of:
collecting information from a plurality of consumers;
establishing at least a first consumer grouping and a second consumer grouping;
placing each consumer in either said first consumer grouping or said second consumer grouping based upon said information collected from each consumer;
providing information about said product to said first consumer grouping in a predetermined first format; and
providing information about said product to said second consumer grouping in a predetermined second format which is different than said predetermined first format.

2. The method of claim 1 wherein said information includes a consumers attitudes.

3. The method of claim 1 wherein said information includes a consumers life experiences.

4. The method of claim 1 wherein said first format includes colors, words, designs and sounds.

5. The method of claim 1 wherein said second format includes colors, words, designs and sounds.

6. The method of claim 1 wherein said product is selected from the group consisting of automobiles, laundry products, cosmetics, foods, medicines, appliances, electronics, cameras, disposable absorbent articles, personal hygiene products, and vision products.

7. The method of claim 1 where said information collecting is accomplished through the use of a computer.

8. A method of providing tailored product information to a consumer, said method comprising the steps of:
collecting information from a plurality of consumers regarding their attitudes and life experiences;
establishing at least a first consumer grouping and a second consumer grouping;
placing each consumer in either said first consumer grouping or said second consumer grouping based upon said information collected from each consumer;
providing information about said product to said first consumer grouping in a predetermined first format; and
providing information about said product to said second consumer grouping in a predetermined second format which is different than said predetermined first format.

9. The method of claim 8 wherein said first format includes colors, words, designs and sounds.

10. The method of claim 8 wherein said second format includes colors, words, designs and sounds.

11. The method of claim 8 where said information collecting is accomplished through the use of a computer.

12. The method of claim 8 wherein said product is selected from the group consisting of automobiles, laundry products, cosmetics, foods, medicines, appliances, electronics, cameras, disposable absorbent articles, personal hygiene products, and vision products.

13. A method of providing tailored product information about a catamenial device to a consumer, said method comprising the steps of:
collecting information from a plurality of consumers regarding their menstrual cycle;
establishing at least a first consumer grouping and a second consumer grouping;
placing each consumer in either said first consumer grouping or said second consumer grouping based upon said information collected from each consumer;
providing information about said catamenial device to said first consumer grouping in a predetermined first format; and
providing information about said catamenial device to said second consumer grouping in a predetermined second format which is different than said predetermined first format.

14. The method of claim 13 wherein said first format includes colors, words, designs and sounds.

15. The method of claim 13 wherein said second format includes colors, words, designs and sounds.

16. The method of claim 13 where said information collecting is accomplished through the use of a computer.

17. The method of claim 13 wherein said catamenial device is selected from a group consisting of: sanitary napkins, pantiliners, incontinence devices, interlabial products, and tampons.
